(19) United States
(12) Patent Application Publication
(10) Pub. No.: US 2005/0138753 A1
(43) Pub. Date: Jun. 30, 2005

(54) Boiler tube cleanout system

(76) Inventor: James P. Hufnagel, Muskegon, MI (US)

Correspondence Address: Richard C. Litman;LITMAN LAW OFFICES, LTD., P.O. Box 15035, Arlington, VA, 22215, US

(21) Appl. No.: 10/745,663

(22) Filed: Dec. 29, 2003

(51) Int. Cl. F23J 3/02; B08B 9/043; B08B 9/045

(52) U.S. Cl. 15/316.1; 15/304

(57) ABSTRACT

The present system uses a large volume of low pressure air to propel a free (i.e., physically unattached to any other component of the invention) boiler tube brush through a boiler tube. The system tank receives relatively high pressure from a conventional source, e.g. “shop air” from a standard compressor and tank. A pneumatic or electric switch shuts off incoming air at a relatively low pressure, and simultaneously sends a signal to a trigger switch at the delivery hose output nozzle. Operating the trigger allows the signal to return to the large capacity output valve to which the delivery hose is attached, sending a large volume, low pressure air pulse through the hose and nozzle to pneumatically propel the tube cleaning brush through the boiler tube without hazard. The brush comprises a series of loosely matted fiber discs assembled on a core. Each disc may have a different abrasive quality.

### BACKGROUND OF THE INVENTION

1. Field of the Invention

The present invention relates generally to devices and systems for cleaning various articles, and more specifically to a pneumatic device and system for cleaning out the fire tubes in an industrial boiler. The present cleanout system includes an apparatus for providing a source of low pressure air in a relatively large volume, a delivery nozzle or “gun” for discharging the volume of air through a boiler tube, and a specially configured brush which is pneumatically propelled through the tube to clean out the inner surface of the tube.

2. Description of the Related Art

Industrial boilers are used in a wide variety of applications, for producing heated water (or sometimes other fluid) for heating a building, steam production to turn electrical generators or for powering other equipment, etc. Such industrial boilers are generally arranged with a series of tubes passing through the internal volume of the device. The tubes either contain water (or other liquid) which is heated by combustion within the boiler shell and surrounding the tubes, or the boiler shell contains water or other working fluid and the interiors of the tubes are heated by combustion.

The tubes of such industrial boilers eventually become coated internally with various contaminants, depending upon whether they are fire tube or water tube boilers. These contaminants restrict the heat transfer between the combustion within the tubes and the water surrounding the tubes (in fire tube boilers) or the combustion outside the tubes and liquid within the tubes (for water tube boilers). In either case, the buildup of foreign matter within the tubes can greatly reduce the efficiency of the boiler operation. In fact, studies have been made to determine the optimum point at which boiler operation should be shut down for tube cleaning, depending upon the size of the tubes and boiler, the thickness of the contaminant buildup, and perhaps other factors.

The tubes of water tube boilers eventually become coated internally with calcium and other mineral buildup, which can be extremely difficult and time consuming to remove. The tubes of water tube boilers are often equipped with internal fins and the like for more efficient heat transfer, which prohibit any effective mechanical cleaning of the interiors of the tubes. Fire tube boiler tubes are also eventually coated internally with combustion byproducts, generally in the form of solid carbon particles (ash and soot). As the fire tubes do not include any inwardly protruding fins and the like for heat transfer, and the combustion byproducts coating the interiors of the tubes are generally relatively soft and do not adhere strongly to the interiors of the tubes, they can generally be removed by brushing.

Accordingly, various techniques have been developed in the past for removing the soot and other combustion byproduct buildup from the interior walls of the tubes of fire tube boilers. Most such techniques involve the use of relatively long pushrods which are used to push a brush through the length of the tube running through the boiler. This process is tedious, and must be done for each tube of the boiler. A later improvement is the use of pneumatic pressure to blow a brush or similar device through each tube. However, such pneumatic devices of the prior art all use relatively high pressure, which can be hazardous to both the boiler tubes and other environment as well as to persons engaged in the operation and working in the immediate area.

The present invention provides a solution to this problem by means of a system using relatively large volumes of low pressure air to propel a brush device through the tubes of a fire tube boiler, for cleaning the interiors of the tubes. The present boiler cleaning system includes a pneumatic tank having a series of valves which limit the amount of air pressure which may be built up in the tank, from a conventional source of relatively high air pressure (“shop air”). The present cleanout device also includes a series of rapidly acting valves which release the relatively low air pressure within the supply tank almost immediately, in order to provide a pulse of low pressure air to propel the cleaning tool harmlessly through the tube. The cleaning tool used with the present invention is also novel in that it preferably includes a series of brush elements thereon, each of which accomplishes a different aspect of the cleaning.

A discussion of the related art of which the present inventor is aware, and its differences and distinctions from the present invention, is provided below.

U.S. Pat. No. 650,451 issued on May 29, 1900 to James J. Byers, titled “Tube Cleaner,” describes a boiler tube cleanout brush having a specific configuration. The Byers brush includes cutting blades extending in opposite spiral patterns from a central shaft, with a wire brush disposed between the two spiral blades. The Byers brush is pushed through the boiler tubes by mechanical means (e.g., a long pushrod). Byers does not disclose any pneumatic means for propelling his brush through the boiler tubes, and in fact teaches away from such a system due to the porous nature of his brush which would allow any differential in air pressure on one side to pass through the brush, rather than propelling the brush through the boiler tube.

U.S. Pat. No. 1,133,262 issued on Mar. 30, 1915 to James O. Casaday, titled “Rotative Boiler Tube Cleaner,” describes a mechanical device which somewhat resembles a cutting head used in well drilling operations. A series of peripheral cutting elements is disposed about a rotary shaft, with the assembly serving to break up and cut away scale deposits within the tubes of a water tube type boiler. The device must be rotated by mechanical means. It cannot be propelled pneumatically through the tube, due to the hard scale buildup within such water tubes. The Casaday device is unsuitable for use in cleaning fire tubes, as only mechanical cutting elements are provided on the tool; no brushes are provided.

U.S. Pat. No. 1,598,771 issued on Sep. 7, 1926 to Charles C. Gerhardt, titled “Boiler Tube Cleaning Brush,” describes such a brush having a series of radially extending bristle groups. Gerhardt also provides a pneumatic seal at one end of his brush assembly, for air pressure to act upon in order to propel the brush through the boiler tube. However, Gerhardt does not describe any means of generating the required pneumatic pressure or volume for propelling his brush through a boiler tube. The present invention provides specific equipment for producing the desired high volume and low pressure charge of air for propelling the brush through the boiler tubes. The brush of the present invention is also novel, in that it may provide multiple abrasive grades for scouring and polishing the inside of the tube in a single pass through the tube.

U.S. Pat. No. 2,631,113 issued on Mar. 10, 1953 to John V. O'Brien, titled “Method Of And Apparatus Employing An Elongated Flexible Member For Cleaning Out Obstructions From Conduits,” describes the construction of a cable having a flexible core wrapped with a spiral spring wire. Such devices are commonly used for sewer and drain cleanout work, and require some form of manual or power rotation to be applied thereto in order to rotate the cutting elements at the distal end of the cable. The O'Brien tool teaches away from the present cleanout system, as the O'Brien tool cannot be propelled pneumatically through a tube or other passage.

U.S. Pat. No. 2,631,114 issued on Mar. 10, 1953 to John V. O'Brien, titled “Method Of Cleaning Out Obstructions From Conduits,” is a divisional patent from the '113 U.S. Patent to the same inventor, discussed immediately above. The same points of difference noted in that discussion, are seen to apply here as well.

U.S. Pat. No. 3,354,490 issued on Nov. 28, 1967 to Don G. Masters et al., titled “Boiler Tube Cleaning Apparatus,” describes an auger drive system for rotating and driving a flexible cable through a tube or the like. The drive system includes horizontal and vertical tracks, for aligning the driving device with the various tubes of the boiler. The device of the Masters et al. '490 U.S. Patent is more closely related to the devices of the '113 and '114 U.S. Patents to O'Brien discussed above, as it provides for the rotation of an elongate flexible shaft. Masters et al. do not disclose any form of pneumatic propulsion for a tube cleanout brush, nor a brush compatible with such a pneumatic propulsion system.

U.S. Pat. No. 4,011,100 issued on Mar. 8, 1977 to Louis A. R. Ross, titled “Pipe Cleaning Method And Apparatus,” describes two embodiments of a device utilizing a pneumatically driven motor to rotate a cleaning element, or to rotate blower jets for blowing dust from the interior walls of a duct. The pneumatic motor may also provide linear propulsion for the device, but the device requires a mechanical restraining cable to be connected thereto and a separate line to serve as the pneumatic supply. No means of providing a high volume of low pressure air for propelling a brush through a tube, is disclosed by Ross.

U.S. Pat. No. 4,822,430 issued on Apr. 18, 1989 to Victor V. Carberry, titled “Method And Apparatus For Cleaning Boiler Burners,” describes a pneumatically powered tube cleanout tool. However, rather than using low pressure air to propel a series of brushes through a tube, Carberry uses a pneumatically powered rotary motor which he passes through the tube. The motor is supplied with pressurized air by a long hose which is extended through the tube as the tool passes through the tube. The motor rotates cutting blades on the front thereof, which dislodge scale and deposits from the inner surface of the tube. The present system does not utilize any form of rotary cutting blades, but rather uses a series of discs having different abrasive grades to remove deposits and polish the interior of the tube.

U.S. Pat. No. 4,872,834 issued on Oct. 10, 1989 to John W. Williams, Jr., titled “Recovery Boiler Port Cleaner,” describes a device which is permanently affixed to the outer wall of a recovery boiler, to periodically clean the air port of the boiler for optimum air flow therethrough. The device is pneumatically operated, but does nothing more than reciprocate inwardly and outwardly to thrust a cleaning blade into the air port. No means of providing a large volume of air under low pressure to drive a free brush completely through an elongate boiler tube, is disclosed by Williams, Jr. Moreover, Williams, Jr. requires a source of electrical power to operate an automatic timer for his device. While the present system may be electrically operated, it may also be operated strictly by means of pneumatic pressure with no requirement for electrical power.

U.S. Pat. No. 6,467,121 issued on Oct. 22, 2002 to Joseph J. Franzino et al., titled “Rotary Tube Scrubber,” describes a rotary brush configuration having a series of radially extending, flexible arms each having a longitudinal cutting edge thereon, with each of the arms having a circumferential discontinuity therebetween. The Franzino et al. brush must be mechanically driven by a rotary shaft, in order to clean the interior walls of the boiler tube. Franzino et al. do not disclose any pneumatic means of propelling a free brush through a boiler tube, and their brush, with its longitudinally disposed cutting edges, cannot provide any real degree of cleaning action unless it is rotated within the tube.

Japanese Patent Publication No. 2002-277,192 published on Sep. 25, 2002 to Kurita Engineering Co. Ltd., titled “Method For Cleaning Boiler,” describes (according to the drawing and English abstract) a tube cleanout system utilizing a cleaning fluid mixed with water. The boiler is emptied and the water and cleaning fluid mixture is pumped through the boiler to clean the interiors of the boiler tubes. Neither mechanical brushing nor means of pneumatically propelling such free brushes through the tubes, is apparent in the '192 Japanese Patent Publication.

The website for Scaleaway Tools & Equipment Ltd., accessed on May 2, 2003, describes an electric motor which drives a flexible rotary shaft to power a rotary tool at the shaft end opposite the motor. A series of different cleaning tools and brushes is also disclosed, but for those brushes with flexible bristle elements, no pneumatic seal is apparent.

Finally, the website for Goodway Technologies, accessed on May 6, 2003, describes a pneumatic gun for use in pneumatically propelling a cleaning element through the tube of a boiler. The Goodway website specifically states that the gun requires a minimum of 90 psi, with up to 120 psi being allowable. This is more than an order of magnitude higher than the air pressure provided with the present system. Goodway makes no disclosure of any large volume air supply, as provided with the present invention. The use of relatively low air volumes, results in a need for relatively high pressures in order to provide sufficient pneumatic propulsive energy to propel the cleanout element through the tube of the boiler. However, the use of such high air pressures can be hazardous, and results in the cleanout element becoming a projectile (the word used by Goodway in describing their cleanout element). The difference between the Goodway system and the present invention is somewhat analogous to the difference between the air pressure developed by an air rifle to fire a BB or pellet, versus the air pressure stored in a small balloon. The total propulsive energy available for release is comparable, but the high pressure developed by the air rifle is considerably more dangerous. It is also noted that the Goodway projectiles are formed of a soft and dense foam, which while possibly reducing the potential hazard of their high velocity passage through the boiler tube due to the high pressure air used, cannot provide the cleaning and polishing action of the multiple grades of abrasive materials used in each of the scrubbing elements of the present invention.

None of the above inventions and patents, taken either singly or in combination, is seen to describe the instant invention as claimed. Thus a boiler tube cleanout system solving the aforementioned problems is desired.

### SUMMARY OF THE INVENTION

The present boiler tube cleanout system propels a tube brush pneumatically through a boiler tube by means of a relatively large air volume delivered under relatively low pressure. This is accomplished by limiting the input pressure of a conventional source of pneumatic pressure, e.g. “shop air,” which is normally supplied at between 90 and 120 pounds per square inch (psi), depending upon the setting of the compressor regulator. The present system includes an air tank with an input valve which shuts off incoming airflow when the tank pressure reaches a relatively low value, e.g. on the order of seven to eight psi. An air supply hose extends from an output valve on the tank, with a trigger operated pneumatic nozzle at the distal end thereof.

Signal and return lines extend along the hose. Once the tank is pressurized, airflow passes through a signal line to the trigger. Pulling the trigger actuates a switch at the nozzle end of the signal line to allow airflow to return to the output valve through the return line, signaling the output valve to open and provide a large volume of air from the previously filled tank. This propels a tube cleanout brush through the tube, which scrubs away any soot and/or other foreign matter which has been relatively loosely deposited on the inner surface of the tube.

The tube brush is free, i.e. not attached in any way to any of the apparatus of the present invention. The brush preferably includes a series of abrasive discs thereon, arranged sequentially along a central rod or tube. A non-porous backing is applied to the trailing end of the assembly, to preclude airflow through the porous discs of the tube brush assembly. The abrasive discs are preferably formed of a loosely matted plastic strand material, which may or may not be impregnated with harder abrasive material as desired. Such material is available under the trade name of Scotchbrite®, and is available in a number of different densities and abrasive grades to provide different degrees of abrasion as desired.

The operating system for the present boiler tube cleanout system is preferably entirely pneumatic, in order to avoid the need for electric power in addition to the conventional “shop air” pneumatic source needed for the operation of the present invention. However, the various switches and valves associated with the operation of the present invention may alternatively be of a type providing for electric actuation, if so desired.

### BRIEF DESCRIPTION OF THE DRAWINGS

FIG. 1 is an environmental, perspective view of a boiler tube cleanout system according to the present invention, showing its operation and use.

FIG. 2 is a detailed perspective view of the boiler tube cleanout apparatus of FIG. 1, showing further details thereof.

FIG. 3 is a detailed perspective view of the pneumatic outlet nozzle used with the apparatus of FIG. 1.

FIG. 4 is a schematic diagram of the pneumatic operating system of the present tube cleanout apparatus.

FIG. 5 is a schematic diagram of an alternative electrically controlled pneumatic system for use with the present invention.

FIG. 6 is an exploded perspective view of an exemplary tube cleanout brush which may be used with the present invention.

Similar reference characters denote corresponding features consistently throughout the attached drawings.

### DETAILED DESCRIPTION OF THE PREFERRED EMBODIMENTS

The present invention comprises various embodiments of a boiler tube cleanout system, for cleaning soot and combustion byproducts from the interiors of the fire tubes in a fire tube type boiler. The present system provides numerous advantages over previously developed boiler tube cleaning systems, in that the present system utilizes a relatively large volume of relatively low pressure air to propel a brush pneumatically through each of the tubes of the boiler. The present invention is preferably operated and controlled by a purely pneumatic system, but may alternatively use an electric control system to control and operate the pneumatics of the device, if so desired. The brushes which are pneumatically propelled through the boiler tubes are also specialized, with each brush preferably including a series of brush elements thereon, with each element being of a different abrasive grade for optimum cleaning.

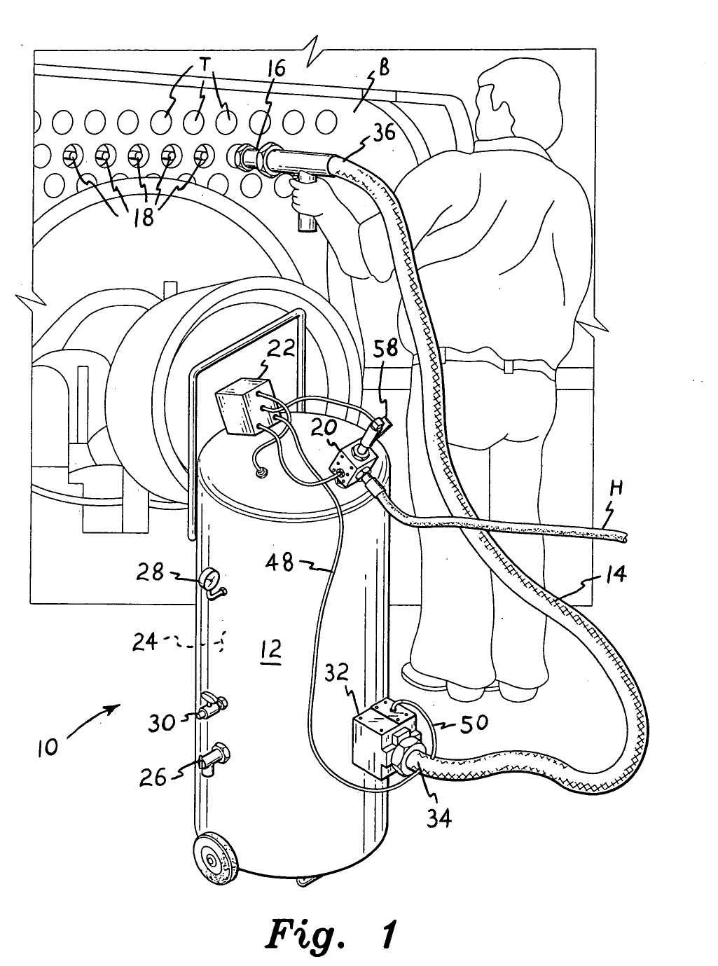

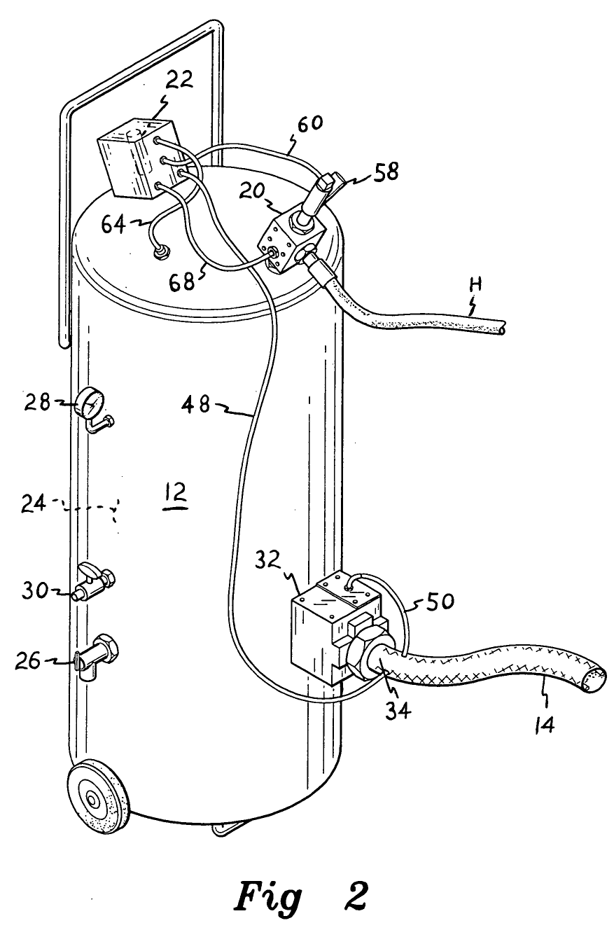

FIGS. 1 and 2 provide perspective views of the air delivery tank and apparatus of the present invention, with FIG. 1 being an environmental view showing additional components and operation of the system. In FIG. 1, the system 10 is shown being used to clean out a series of tubes T in a boiler B, after the ends of the tubes have been accessed by opening or removing the access panel conventionally installed therewith. The system 10 includes a low pressure air tank 12 which receives air from a conventional source of relatively high pressure air (e.g., “shop air,” or perhaps a portable compressor) which is delivered to the air tank 12 by a conventional high pressure air hose H. A high volume, low pressure delivery hose 14 extends from the low pressure air tank 12 to an outlet nozzle 16 at the distal end thereof, to supply a large volume of air under low pressure from the tank 12 to propel a cleanout brush 18 through the boiler tube T.

A series of brushes 18 may be placed in the inlets of a number of the boiler tubes T, generally as shown in FIG. 1, with the operator of the present system 10 merely shifting the outlet nozzle 16 from tube to tube to propel each brush 18 through its respective tube T. The brushes 18 are retrieved at the opposite, downstream ends of the tubes T for reuse. The opposite ends of the tubes T may be covered with a temporary cover (tarp, etc.) to collect the brushes 18 and the soot and other combustion byproducts brushed from the interiors of the tubes T during the cleaning operation. A slight vacuum may be applied to the downstream ends of the tubes T in order to avoid blowback of the soot through the tubes; this is conventional in such operations.

The air tank 12 is a low pressure device, as noted further above. While the tank 12 is preferably rated for relatively high pressure, the components of the present system 10 render the tank 12 incapable of accepting or storing air at pressure significantly over the nominal operating pressure of seven to eight pounds per square inch (psi) for the system 10. Air pressure within the tank 12 is controlled by a pneumatic inlet valve 20 between the high pressure inlet hose H and the tank 12. The inlet valve 20 receives a signal (preferably pneumatic, but alternately by electrical means) from a pneumatic (or electric) switch 22, to close the inlet valve 20 to the incoming higher pressure shop air delivered by the inlet hose H when the internal volume 24 of the tank 12 reaches a predetermined pressure.

Additional insurance that the tank 12 cannot exceed the desired low pressure is provided by a relief valve 26 extending from the tank 12, and set to release the tank pressure if it exceeds the nominal operating pressure by some predetermined amount, e.g. twelve psi. A pressure gauge 28 is also provided for monitoring the internal pressure of the tank 12, with a dump valve 30 also provided so the operator may relieve the internal pressure within the tank 12 when the system 10 is not in use.

A high volume pneumatic outlet valve 32 is also provided on the tank 12, communicating with the internal volume 24 of the tank 12. The delivery hose 14 extends from its outlet valve connection end 34 to its opposite nozzle end 36, from which the delivery nozzle 16 extends. The outlet valve 32 is actuated by a trigger on the delivery nozzle 16, as explained below.

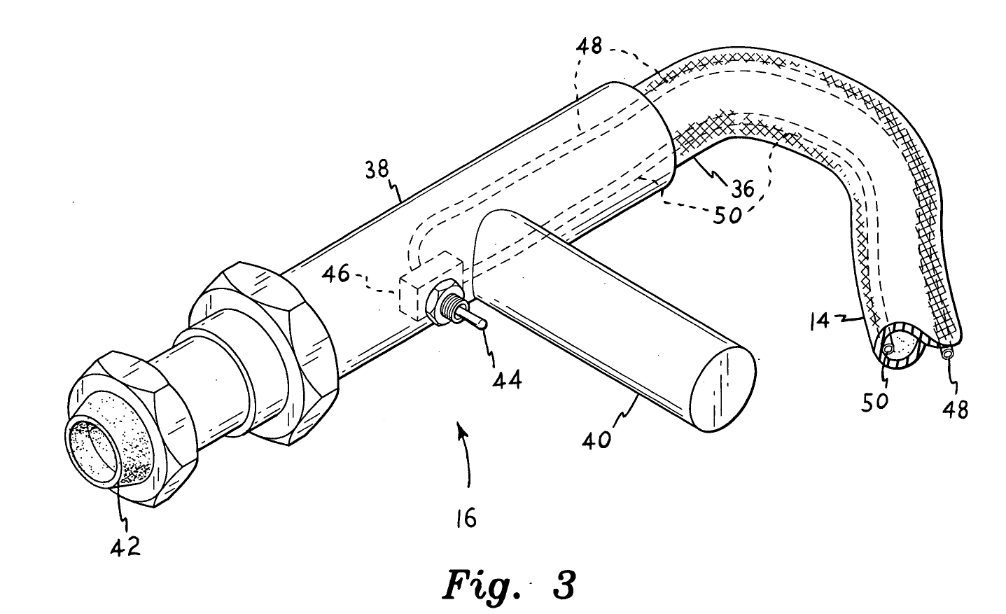

FIG. 3 provides a detailed illustration of the outlet nozzle 16 of the present system. The nozzle 16 may include a rigid, or semi-rigid, body portion 38 to which the nozzle end 36 of the delivery hose 14 is connected. A handle 40 may be provided, extending from the body portion 38. The opposite end of the body 38 has an outlet port 42 extending therefrom. The outlet port 42 is preferably formed of a pliable, resilient material in order to provide a good seal against the end of a boiler tube, and may be provided in any of a number of different sizes or diameters in order to fit different diameter boiler tubes. The nozzle body 38 and outlet port 42 are preferably configured to provide easy interchange of different size or diameter ports 42, as required.

A trigger 44 (which may alternatively comprise a pushbutton, rocker switch, etc., rather than the toggle depicted in FIG. 3) serves to actuate a switch 46 at the nozzle body 38, with the switch 46 triggering the outlet valve 32 at the tank 12. The switch 46 is preferably a pneumatic device, with operation of the trigger 44 opening the pneumatic valve comprising the pneumatic switch 46. Alternatively, the switch 46 may be electrically actuated, with operation of the trigger 44 closing the electrical contacts of the switch to close the electrical circuit. A signal line 48 (pneumatic or electric, depending upon the operating system used) extends from the air pressure switch 22 on the tank 12 to the trigger operated switch 46 at the outlet nozzle 16. A return line 50 (pneumatic or electric) extends from the switch 46, back to the outlet valve 32. The signal and return lines are preferably enclosed within the hose 14, for damage protection.

Completing the circuit by operating the switch 46, allows a pneumatic or electric signal to pass from the air pressure switch 22 to the outlet valve 32, opening the outlet valve 32 to release the air pressure within the tank 12 to expel a large volume of low pressure air from the nozzle 38. This serves to propel a tube cleanout brush 18 through a boiler tube T, when the outlet port 42 of the nozzle assembly 16 is placed against the end of a boiler tube T in which a brush 18 has been placed.

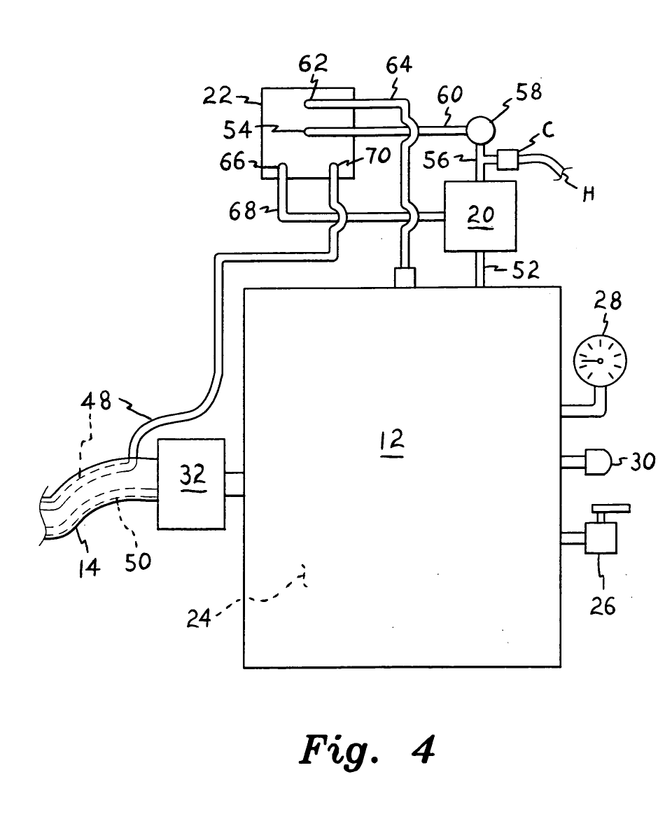

FIG. 4 provides a schematic diagram of the pneumatic operating system of the present invention, less the distal end of the low pressure delivery hose 14 and its outlet nozzle. The internal volume 24 of the tank 12 is supplied with air from the inlet valve 20, which communicates pneumatically with the tank 12 by means of an inlet line 52. The inlet valve 20 is supplied with air from a relatively high pressure source via a conventional high pressure air hose H connected to a shop air supply or other suitable source of air pressure. A conventional quick disconnect coupling C may be used to connect the air pressure supply hose H to the tank 12 apparatus. The inlet valve 20 opens in accordance with signals provided by the pressure switch 22, which signals the valve 20 to close to incoming air when the tank 12 pressure reaches a predetermined point. Thus, the tank 12 is filled quite rapidly due to the high pressure of the incoming air from the hose H and through the valve 20, but the incoming airflow is shut off as soon as the tank 12 pressure reaches the predetermined desired limit, e.g. seven to eight psi.

The pressure switch 22 may be considered as a double pole, double toggle type switch, but operating by means of pneumatic principles and systems in the schematic system illustrated in FIG. 4 of the drawings. The common port 54 of the switch 22 receives airflow under pressure from the incoming air delivered by the high pressure supply hose H, with flow being divided between the inlet valve 20 and the switch 22 at a tee fitting 56. An air pressure regulator 58 may be installed in the switch supply line 60 between the tee 54 and the pressure switch 22, as required. While many types of pneumatic switches may be capable of functioning when supplied with relatively high pressure shop air, it is possible to use less costly switches by reducing the incoming pressure to the switch 22 to around twenty five psi or less by means of the regulator 58.

The sense port 62 of the pneumatic switch 22 receives a pressure signal by means of a tank pressure connection line 64, extending from the tank 12 to the switch 22. Tank pressure to either side of a predetermined cutoff or switch point, will cause the switch 22 to open or close pneumatic valves or ports therein, thereby delivering or cutting off pneumatic flow to the inlet valve 20 and to the air pressure trigger switch 46 at the nozzle 16 shown in FIG. 3. When air pressure in the tank 12 is below the predetermined set point, e.g. seven to eight psi, the inlet valve port 66 of the switch 22 is normally open, allowing air to flow from the common supply line 60, through the switch 22, to the inlet valve 20 via the line 68, providing pneumatic pressure to hold the inlet valve 20 open to allow the tank 12 to fill.

The pneumatic switch 22 includes another pneumatic switch port 70 which is normally closed when the tank pressure is below the predetermined switch point for the pneumatic switch 22. This port 70 is connected to the trigger switch 46 at the nozzle 16 (shown in FIG. 3) by the signal line 48, which extends from the normally closed port 70 to the trigger switch 46 via the low pressure delivery hose 14. So long as this port 70 is closed, air cannot flow from the pneumatic switch 22 to the trigger switch 46. Thus, operation of the trigger switch 46 will not result in air flow back to the outlet valve 32 via the return line 50, which results in the outlet valve 32 remaining closed to prevent release of air and operation of the system.

However, once the air pressure in the tank 12 reaches the predetermined switch point, this pressure is sensed by the pneumatic switch 22 via the tank pressure connection line 64 to the sense port 62 of the switch 22. This cutoff pressure causes the switch 22 to close the normally open port 66, thus cutting off air flow to the inlet valve 20 to cause the inlet valve 20 to close, thereby stopping any further pressure buildup in the tank 12 beyond the preset cutoff point. Simultaneously, the switch 22 opens the normally closed port 70, allowing air to flow to the trigger switch 46 via the signal line 48. Actuation of the trigger 44 opens the valve at the pneumatic trigger switch 46 to allow air to flow from the open port 70, along the signal line 48, through the trigger switch 46, and back along the return line 50 to actuate the outlet valve 32, thereby allowing the large volume of low pressure air within the tank 12 to be released.

The above described sudden release of the volume of air within the tank 12 results in a pressure drop, as well. When the pressure drops below the predetermined set point for the switch 22, the previously opened port 70 to the trigger switch 46 reverts to its normally closed condition, thereby ceasing operation of the trigger switch 46. Simultaneously, the previously closed port 66 reverts to its normally open condition, thereby allowing air to flow from the common supply line 60 through the switch 22 to the inlet valve 20, thereby signaling the inlet valve 20 to open in order to refill the tank 12 with another volume of air for further operation of the present system. The capacity of the inlet and outlet valves 20 and 32 is preferably relatively large, in order to allow rapid cycling of the device and rapid discharge of the air volume within the tank 12 when the trigger 48 of the nozzle 16 is actuated.

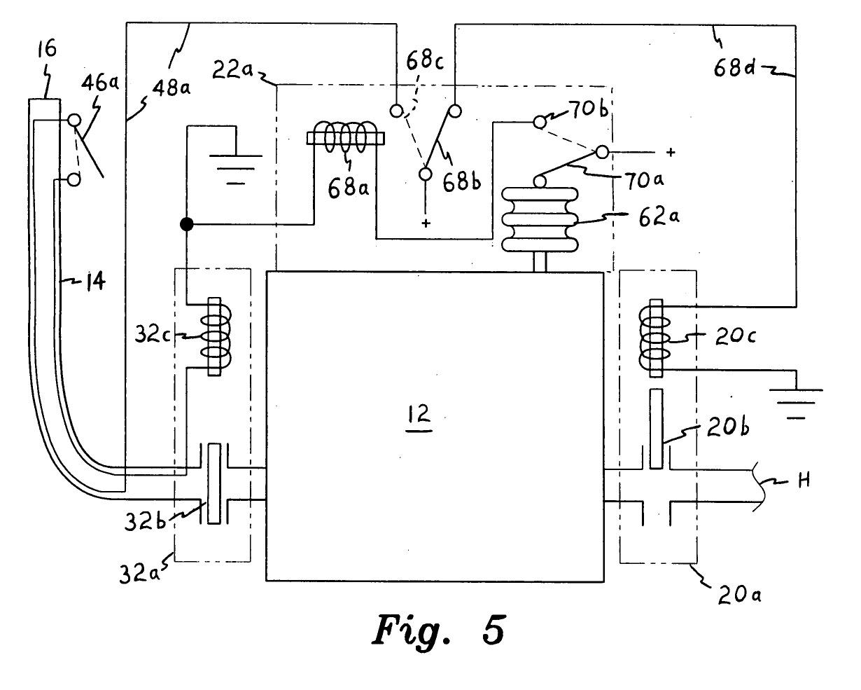

FIG. 5 of the drawings provides a schematic view of an exemplary electrical system for the present invention, including the delivery hose with an electrically actuated trigger switch at the nozzle thereof. The tank 12 is essentially identical to the tank 12 of other embodiments discussed further above, and receives air pressure from a relatively high pressure supply line or hose H. However, the inlet valve 20a (the housing of which is shown in broken lines in FIG. 5) is an electrically actuated device, having a solenoid valve 20b therein actuated by a solenoid 20c to control the flow of air into the tank 12. The outlet valve 32a (in broken lines) is also electrically controlled, by a solenoid valve 32b actuated by a solenoid 32c.

The operation of the two valves 20a and 32a is controlled by a switch 22a, with the housing shown in broken lines in FIG. 5. The switch 22a is a double pole, double toggle type switch, just as in the pneumatic switch 22 of the pneumatically operated system discussed further above. However, the switch 22a of the system of FIG. 5 is electrically operated. The switch 22a receives an air pressure signal from a pressure transducer 62a, which may be considered somewhat analogous to the sense port 62 of the pneumatic system of FIG. 4. The transducer 62a actuates a normally open, double throw switch 70a, depending upon the preset tank pressure required to operate the switch 70a. When the pressure in the tank 12 reaches the predetermined set point, e.g. seven to eight psi, the transducer 62a closes the switch 70a, with the closed position shown in broken lines in FIG. 5.

This allows electrical power to flow across a closed contact 70b, thereby sending electrical power to a solenoid 68a to actuate a double throw switch 68b somewhat analogous to the normally open pneumatic port 68 of the system of FIG. 5. The switch 68b is normally closed (as shown in solid lines in FIG. 5) which allows electrical power to flow through the switch 68b to the solenoid 20c of the inlet valve 20a, thereby holding the valve 20b open to allow air to flow into the tank 12 from the supply line or hose H. However, when the internal pressure in the tank 12 reaches the predetermined set point, the transducer 62a closes the normally open switch 70a to actuate the solenoid 68a, thereby switching the switch 68b from its normal position to its alternate position 68c as shown in broken lines in FIG. 5.

The now open switch position 68b cuts off electrical power through the line 68d to the inlet valve control solenoid 20c, thereby releasing the valve 20b to close off incoming air flow from the hose or line H to stabilize the internal pressure in the tank 12 at the desired level. Simultaneously, the alternate switch position 68c allows electrical power to flow through the switch 68c to the signal line 48a, to the trigger switch 46a at the nozzle 16. When the trigger switch 46a is closed to the position 46b shown in broken lines, the circuit from the switch position 68c, through the signal line 48a, across the trigger switch at 46c, and back along the return line 50a to the outlet valve solenoid 32c is completed. This actuates the solenoid 32c to open the valve 32b, thereby releasing the previously built up pressure within the tank 12.

When the pressure within the tank 12 drops below the set point for the pressure transducer 62a and switch 70a, the switch 70a reverts to its normally open position as shown in solid lines, thereby opening the circuit to the solenoid 68a. This causes the switch position 68c to revert to its normally closed position 68b, shown in solid lines in FIG. 5. This closes the circuit to the inlet valve solenoid 20c via the line 68d, causing the valve 20b to open to allow air flow to replenish the pressure within the tank 12. Simultaneously, the circuit to the trigger switch 46a is opened, thereby disabling the trigger switch to prevent further operation until the tank pressure builds up sufficiently to close the pressure switch 70a to its position 70b shown in broken lines in FIG. 5.

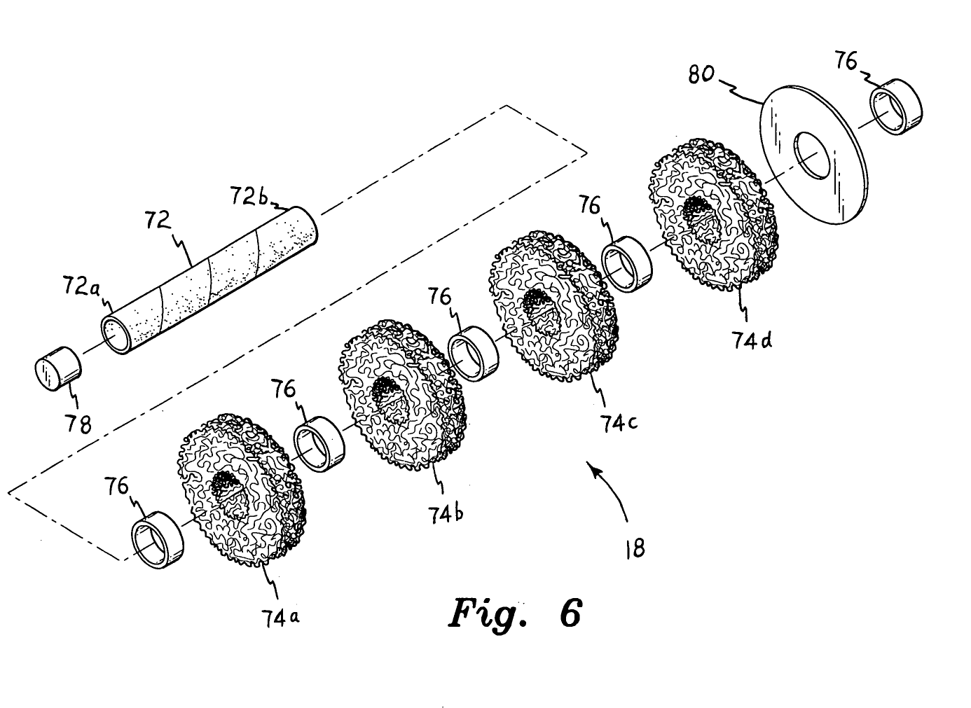

FIG. 6 provides an exploded perspective view of an exemplary boiler tube cleanout brush 18 for use with the present system. The brush or cleaning element 18 is preferably relatively light weight, in order to avoid potential injury to persons or damage to property as it leaves the downstream end of a boiler tube. The relatively low pressure used in the present system, along with the conventional tarps or covers used to close off the downstream end of the boiler during the cleaning operation, will generally preclude such injury or damage in any event. However, the light weight of the cleanout brushes 18 of the present system, provides an even greater margin of safety.

The brush 18 has a hollow central core 72 which may be formed of light cardboard stock, plastic, or other suitable light weight material as desired. A series of toroidal brush elements or pads, e.g. pads 74a, 74b, 74c, and 74d, is assembled sequentially along the core 72, with a tubular spacer 76 placed along the core 72 between each brush pad 74a through 74d to space the pads 74a through 74d apart from one another and at each end of the core 72 to retain the leading and trailing brush pads on the core 72. As the boiler tube brush 18 of the present system is propelled through a boiler tube by pneumatic pressure, some means must be provided to prevent the propelling air pressure from passing through the brush 18. This may be accomplished by installing a plug 78 (or tape, etc.) in the leading end 72a (or trailing end 72b) of the core 72, and providing a non-porous disc 80 at the trailing end 72b of the core 72 to block any significant air flow through the porous pads. Alternatively, the tube may remain open or only partially blocked, in order to allow air flow therethrough to blow soot and other loose material from the tube in advance of the passage of the brush 18, if so desired. Also, each of the pads 74a through 74d may have a non-porous disc provided therewith, with the discs serving to stiffen and reinforce the pads 74a through 74d to provide better contact with the interior walls of the tube.

The brush pads 74a through 74d are formed of a flexible, porous, loosely matted abrasive material, suited for scrubbing and polishing soot and other combustion byproducts from the interior wall of a boiler tube as the pads 74a through 74d are pushed through the tube by the air pressure expelled from the tank 12 of the present boiler tube cleanout system. Scotchbrite® material manufactured by the 3M Company has been found to be well suited for such a task.

Scotchbrite® material is provided in a wide variety of different abrasive grades, and it is preferred that the cleanout brush 18 of the present invention utilize a series of different pads, e.g. pads 74a through 74d, each of a different abrasive grade from one another, or at least comprising two different abrasive grades. As an example, the leading pad 74a positioned adjacent the leading end 72a of the core 72 may be formed of relatively coarse material, in order to scrub away any heavy deposits of material on the interior walls of the tubes. The next pad 74b, or pads 74b and 74c, may have intermediate abrasive properties, while the last pad 74d at the trailing end 72d of the core 72 may be of a relatively fine abrasive grade, in order to perform a final polish of the interior of the tube as the brush element 18 is propelled therethrough. It will be seen that a greater or lesser number of such pads 74a through 74d, with varying degrees of abrasive harshness, may be installed upon a core 72 to customize the brush element 18 as desired, depending upon the type(s) and amount(s) of combustion byproduct(s) which may be built up within the boiler tubes.

In conclusion, the present boiler tube cleanout system greatly facilitates the periodic cleaning of fire tube boiler tubes, which is required for optimum efficiency of such devices. The relatively low pneumatic pressure used by the present system also greatly enhances safety during such operations. After accessing the boiler tubes for cleaning, a person using the present invention need only ready the system for operation by confirming that the tank dump valve is closed, and perhaps actuating any electrical system where an electrically controlled embodiment is used. The user may then connect a conventional source of pneumatic pressure (e.g., “shop air,” or perhaps a portable compressor transported to the job site) using a conventional high pressure air hose or the like, and install one or more brush elements (preferably a series of such elements, for greater efficiency) in the exposed ends of the boiler tubes.

The user then need only apply the air outlet nozzle to the end of each boiler tube in which a cleanout brush has been installed, and actuate the trigger at the nozzle to release the entire volume of low pressure air stored in the tank to push the brush through the tube, thereby scrubbing and removing any deposits within the tube. The operation is repeated for each tube, with the recycle time being very low due to the relatively large capacity of the valves used and the relatively high pressure (e.g., perhaps up to 150 psi) provided by conventional pneumatic sources. The result is a significant savings of time in the boiler cleaning operation, as well as a significantly safer system for cleaning the tubes in a fire tube boiler.

It is to be understood that the present invention is not limited to the embodiments described above, but encompasses any and all embodiments within the scope of the following claims.

1. A boiler tube cleanout system, comprising:
an air storage tank having an internal volume, selectively containing air at a predetermined low pressure and accepting airflow from a high pressure air source;
an inlet valve disposed upon said tank, communicating with said internal volume of said tank and accepting the airflow from the high pressure air source;
an air pressure switch sensing the air pressure within said tank, communicating with said inlet valve and shutting off the airflow from the high pressure air source when the air pressure within said tank reaches a predetermined level;
a high capacity outlet valve communicating with said internal volume of said tank;
a large volume pneumatic delivery hose extending from said outlet valve, said delivery hose having:
an outlet valve connection end; and
a nozzle end opposite said outlet valve connection end;
a large volume outlet nozzle extending from said nozzle end of said delivery hose;
a trigger operated switch disposed with said outlet nozzle;
a signal line extending from said air pressure switch to said trigger operated switch;
a return line extending from said trigger operated switch to said outlet valve; and
at least one pneumatically propelled boiler tube cleaning brush; whereby
pressurizing said tank to a predetermined low pressure actuates said air pressure switch to shut off the airflow from the high pressure air source and sends a signal to said trigger operated switch via said signal line and actuating said trigger operated switch sends a signal to said outlet valve via said return line, thereby releasing the volume of low pressure air contained within said tank and pneumatically propelling said boiler tube cleaning brush through the boiler tube when said boiler tube cleaning brush is placed within the boiler tube and said outlet nozzle is applied to one end of the boiler tube.

2. The boiler tube cleanout system according to claim 1, wherein said inlet valve, said air pressure switch, said outlet valve, and said trigger operated switch are each pneumatically actuated and communicate pneumatically with one another.

3. The boiler tube cleanout system according to claim 1, wherein said inlet valve, said air pressure switch, said outlet valve, and said trigger operated switch are each electrically actuated and communicate electrically with one another.

4. The boiler tube cleanout system according to claim 1, wherein said signal line and said return line are protectively enclosed within said delivery hose.

5. The boiler tube cleanout system according to claim 1, further including:
an intermediate regulator disposed between the high pressure air source and said air pressure switch; and
a pressure relief valve, a pressure dump valve, and a pressure gauge disposed upon said tank and communicating with said internal storage volume thereof.

6. The boiler tube cleanout system according to claim 1, wherein said boiler tube cleaning brush comprises:
a central core having a leading end and a trailing end opposite said leading end;
a plurality of flexible, porous, loosely matted abrasive pads disposed upon and spaced apart along said central core, with each of said pads having a toroid configuration; and
a non-porous disc disposed upon said trailing end of said central core and immediately adjacent one of said abrasive pads, precluding significant airflow through said porous abrasive pads.

7. The boiler tube cleanout system according to claim 6, wherein:
said central core comprises a hollow cardboard tube; and
said central core further includes a spacer disposed between each of said abrasive pads disposed thereon.

8. The boiler tube cleanout system according to claim 6, wherein each of said abrasive pads is a different abrasive grade from one another.

9. The boiler tube cleanout system according to claim 8, wherein said abrasive pads are disposed upon said central core with at least a leading one of said abrasive pads having a coarse abrasive grade disposed adjacent said leading end of said central core and at least a trailing one of said abrasive pads having a fine abrasive grade disposed adjacent said trailing end of said central core.

10. The boiler tube cleanout system according to claim 9, wherein said boiler tube cleaning brush further includes at least four said abrasive pads distributed along said central core, with at least two said abrasive pads each having an intermediate abrasive grade disposed between said leading and said trailing abrasive pads.

11. A boiler tube cleanout system, comprising:
an air storage tank having an internal volume, selectively containing air at a predetermined low pressure and accepting airflow from a high pressure air source;
an air control system cooperating with said tank;
a delivery hose extending from said air control system;
an outlet nozzle extending from said delivery hose;
at least one pneumatically propelled boiler tube cleaning brush, comprising:
a central core having a leading end and a trailing end opposite said leading end;
a plurality of flexible, porous, loosely matted abrasive pads disposed upon and spaced apart along said central core, with each of said pads having a toroid configuration; and
a non-porous disc disposed upon said trailing end of said central core and immediately adjacent one of said abrasive pads, precluding significant airflow through said abrasive pads.

12. The boiler tube cleanout system according to claim 11, wherein said air control system comprises:
an inlet valve disposed upon said tank, communicating with said internal volume of said air tank and accepting the airflow from the high pressure air source;
an air pressure switch sensing the air pressure within said tank, communicating with said inlet valve and shutting off the airflow from the high pressure air source when the air pressure within said tank reaches a predetermined level;
a high capacity outlet valve communicating with said internal volume of said tank;
said delivery hose having a large volume pneumatic hose extending from said outlet valve, said delivery hose having:
an outlet valve connection end; and
a nozzle end opposite said outlet valve connection end;
said outlet nozzle comprising a large volume nozzle extending from said nozzle end of said delivery hose;
a trigger operated switch disposed with said outlet nozzle;
a signal line extending from said air pressure switch to said trigger operated switch;
a return line extending from said trigger operated switch to said outlet valve; and
at least one pneumatically propelled boiler tube cleaning brush; whereby
pressurizing said tank to a predetermined low pressure actuates said air pressure switch to shut off the airflow from the high pressure air source and sends a signal to said trigger operated switch via said signal line and actuating said trigger operated switch sends a signal to said outlet valve via said return line, thereby releasing the volume of low pressure air contained within said tank and pneumatically propelling said boiler tube cleaning brush through the boiler tube when said boiler tube cleaning brush is placed within the boiler tube and said outlet nozzle is applied to one end of the boiler tube.

13. The boiler tube cleanout system according to claim 12, wherein said inlet valve, said air pressure switch, said outlet valve, and said trigger operated switch are each pneumatically actuated and communicate pneumatically with one another.

14. The boiler tube cleanout system according to claim 12, wherein said inlet valve, said air pressure switch, said outlet valve, and said trigger operated switch are each electrically actuated and communicate electrically with one another.

15. The boiler tube cleanout system according to claim 12, further including:
an intermediate regulator disposed between the high pressure air source and said air pressure switch; and
a pressure relief valve, a pressure dump valve, and a pressure gauge disposed upon said tank and communicating with said internal storage volume thereof.

16. The boiler tube cleanout system according to claim 12, wherein said signal line and said return line are protectively enclosed within said delivery hose.

17. The boiler tube cleanout system according to claim 11, wherein:
said central core comprises a hollow cardboard tube; and
said central core further includes a spacer disposed between each of said abrasive pads disposed thereon.

18. The boiler tube cleanout system according to claim 11, wherein each of said abrasive pads is a different abrasive grade from one another.

19. The boiler tube cleanout system according to claim 18, wherein said abrasive pads are disposed upon said central core with at least a leading one of said abrasive pads having a coarse abrasive grade disposed adjacent said leading end of said central core and at least a trailing one of said abrasive pads having a fine abrasive grade disposed adjacent said trailing end of said central core.

20. The boiler tube cleanout system according to claim 19, wherein said boiler tube cleaning brush further includes at least four said abrasive pads distributed along said central core, with at least two said abrasive pads each having an intermediate abrasive grade disposed between said leading and said trailing abrasive pads.
